(19) United States
(12) Patent Application Publication
(10) Pub. No.: US 2026/0285401 A1
(43) Pub. Date: Sep. 24, 2026

(54) STEERING REQUEST FOR DRIVER-IN-THE-LOOP VEHICLE CONTROL

(71) Applicant: QUALCOMM Incorporated, San Diego, CA (US)

(72) Inventors: Jan VEEN, Hallbergmoos (DE); Benjamin GAUDSZUN, Bibertal OT Schneckenhofen (DE); Sibylle Tanja REBER, Gröbenzell (DE); Irinel TURTUREA, München (DE); Joao Paulo JANSCH PORTO, Philadelphia, PA (US)

(21) Appl. No.: 19/088,362

(22) Filed: Mar. 24, 2025

(51) Int. Cl. B62D 15/02

(52) U.S. Cl. CPC B62D 15/025; B60W 50/10; B60W 2050/0073

(57) ABSTRACT

In some aspects, a device associated with a vehicle may detect a driver interaction based on measured torque on a steering column of the vehicle. The device may transition, in connection with detecting the driver interaction, control of the vehicle from an advanced driver assistance system (ADAS) feature to a driver by outputting a steering request that transitions from a feature steering request associated with the ADAS feature to a driver steering request. Numerous other aspects are described.

### FIELD OF THE DISCLOSURE

Aspects of the present disclosure generally relate to an automated and/or driver assistance system and, for example, to a steering request for driver-in-the-loop vehicle control.

### BACKGROUND

Autonomous driving systems are an emerging technology that allows a vehicle to operate without human input, following a pre-programmed route or responding to real-time environmental conditions. Driver assistance systems, such as an advanced driver assistance system (ADAS), include technologies that provide assistance to a driver of a vehicle, such as technologies to help drivers avoid collisions and/or accidents or otherwise make driving the vehicle safer and/or more efficient. Autonomous driving systems and/or driver assistance systems (e.g., an ADAS) generally use a combination of sensors, cameras, and software algorithms to perceive the environment and make decisions based on the perceived environment. Autonomous driving and/or driver assistance technology may be designed to create a safer, more efficient, and more convenient mode of transportation that reduces the need for human intervention. The development of autonomous driving systems and driver assistance systems has been driven by a convergence of factors (e.g., advancements in sensor technology, artificial intelligence, and machine learning) that have enabled vehicles to sense and process information from the surrounding environment (e.g., road conditions, traffic, and pedestrians).

### SUMMARY

Some aspects described herein relate to a device associated with a vehicle. The device may include a processing system. The processing system may include one or more processors and one or more code-storing memories coupled with the one or more processors. The processing system may be configured to cause the device to detect a driver interaction based on measured torque on a steering column of the vehicle. The processing system may be configured to cause the device to transition, in connection with detecting the driver interaction, control of the vehicle from an advanced driver assistance system (ADAS) feature to a driver by outputting a steering request that transitions from a feature steering request associated with the ADAS feature to a driver steering request.

Some aspects described herein relate to a method performed by a device associated with a vehicle. The method may include detecting a driver interaction based on measured torque on a steering column of the vehicle. The method may include transitioning, in connection with detecting the driver interaction, control of the vehicle from an ADAS feature to a driver by outputting a steering request that transitions from a feature steering request associated with the ADAS feature to a driver steering request.

Some aspects described herein relate to a non-transitory computer-readable medium that stores a set of instructions. The set of instructions, when executed by one or more processors of a device associated with a vehicle, may cause the device to detect a driver interaction based on measured torque on a steering column of the vehicle. The set of instructions, when executed by one or more processors of the device, may cause the device to transition, in connection with detecting the driver interaction, control of the vehicle from an ADAS feature to a driver by outputting a steering request that transitions from a feature steering request associated with the ADAS feature to a driver steering request.

Some aspects described herein relate to an apparatus. The apparatus may include means for detecting a driver interaction based on measured torque on a steering column of a vehicle. The apparatus may include means for transitioning, in connection with detecting the driver interaction, control of the vehicle from an ADAS feature to a driver by outputting a steering request that transitions from a feature steering request associated with the ADAS feature to a driver steering request.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which an autonomous vehicle or a vehicle equipped with an advanced driver assistance system (ADAS) may operate.

FIG. 2 is a diagram of an example on-board system of an autonomous vehicle or a vehicle equipped with an ADAS.

FIG. 3 is a diagram illustrating example components of a device.

FIGS. 4A-4D are diagrams illustrating an example associated with a steering request for driver-in-the-loop (DIL) vehicle control.

FIG. 5 is a flowchart of an example process associated with a steering request for DIL vehicle control.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A vehicle may be equipped with an autonomous driving system and/or advanced driver assistance system (ADAS) that may include one or more features associated with automated driving and/or driver assistance. For example, such a feature may be an automated or assisted steering feature that may control or assist in controlling the lateral movement of the vehicle. In some examples, a feature associated with an automated driving or driver assistance system may be a driver-in-the-loop (DIL) feature. That is, the autonomous driving system or driver assistance system (e.g., ADAS) of the vehicle may activate the feature subject to DIL control of the feature. DIL is a mechanism in which control of the vehicle is transferred between automated control by an automated driving or driver assistance feature (e.g., an ADAS feature) and manual control by the driver based on whether the driver is actively interacting with the vehicle.

In an ADAS with features subject to DIL control, ensuring a seamless transition between an automated driving feature and driver control is important for both system functionality and user experience. For example, in vehicles equipped with ADAS level 2 and level 3 capabilities, the driver may be part of a control loop and may be required to remain attentive and ready to intervene in controlling the vehicle when necessary. Currently, the logic for managing this driver-vehicle interaction utilizes torque limits applied to the steering actuator, based on feature torque requests. This approach, however, introduces dependencies on additional logic within the torque controller, which may be embedded within the steering controller (e.g., a steering electronic control unit (ECU)) supplied by the steering manufacturer.

The dependency on the steering manufacturer's steering controller (e.g., steering ECU) presents challenges, as the steering controller may involve software components that are non-transparent to the ADAS (e.g., an on-board device associated with the ADAS) and not modifiable by entities such as vehicle manufacturers or ADAS developers. This integration challenge may be compounded by the use of special interfaces and code to be implemented at the steering ECU, adding another layer of complexity to the ADAS chain. Moreover, existing torque-limit-based solutions may be incompatible with certain vehicle platform (e.g., ADAS) interfaces, such as those that use pinion angle requests or curvature requests instead of direct torque requests.

Additionally, the use of torque limits at the steering ECU to blend driver and automated feature inputs can lead to performance limitations due to inherent delays. These delays may arise from the time taken for an ADAS-generated request to be processed and actuated by the steering controller. Such latencies can result in discrepancies between the intended and actual vehicle behavior, potentially causing discomfort or unexpected vehicle responses, which can decrease the safety of ADAS features, as well as diminish driver confidence and trust in the ADAS features.

Various aspects relate generally to enhancing the interaction between a driver and an ADAS in a vehicle. Some aspects more specifically relate to a device associated with a vehicle detecting driver interaction based on measured torque on the steering column and transitioning vehicle control from an ADAS feature to the driver by outputting a steering request that transitions from an ADAS feature steering request to a driver steering request.

In some aspects, the detection of driver interaction may include filtering the measured torque, resulting in a filtered measured torque associated with the driver interaction, and detecting the driver interaction based on a comparison of the filtered measured torque to a threshold. The filtering process ensures that the measured torque signal is within a bandwidth that optimizes the system's sensitivity to actual driver inputs while reducing the likelihood of false positives due to noise or other non-driver-related torque signals.

In some aspects, the transition of the steering request from the ADAS feature steering request to the driver steering request may be in accordance with a rate limitation that controls the rate of change of the steering request. This rate limitation mitigates abrupt steering transitions, which may increase safety and decrease driver discomfort. Furthermore, mitigating abrupt steering transitions that could cause mechanical stress on the vehicle's steering components, may conserve the longevity of these components.

In some aspects, the device may extrapolate the driver steering request over an amount of time corresponding to a delay between the outputting of the steering request and the actuator's response to steer the vehicle based on the steering request. By accounting for this delay, the device may improve temporal consistency between the driver's intended input and the vehicle's response, which can lead to more precise control of the vehicle's trajectory, thus increasing safety and reducing the need for subsequent corrective steering maneuvers.

In some aspects, the steering request may be a pinion angle request or a curvature request, thus providing a standardized interface for vehicle control that may facilitate integration with various vehicle systems and potentially simplify the calibration process.

In some aspects, the device may detect a lack of driver interaction based on subsequent measured torque on the steering column. In connection with detecting the lack of driver interaction, the device may transition vehicle control from the driver back to the ADAS feature by outputting a subsequent steering request that transitions from the driver steering request to the ADAS feature steering request.

Particular aspects of the subject matter described in this disclosure can be implemented to realize technical advantages such as enhanced system responsiveness to driver inputs, reduced mechanical stress on steering components, and improved temporal alignment between the driver's steering inputs and the vehicle's steering actuation. These improvements contribute to the precise and reliable operation of the vehicle's steering system, which may conserve processing resources, memory resources, network resources, or the like, as well as improve the safety of ADAS features and increase driver comfort when transitioning control of the vehicle between ADAS features and driver control.

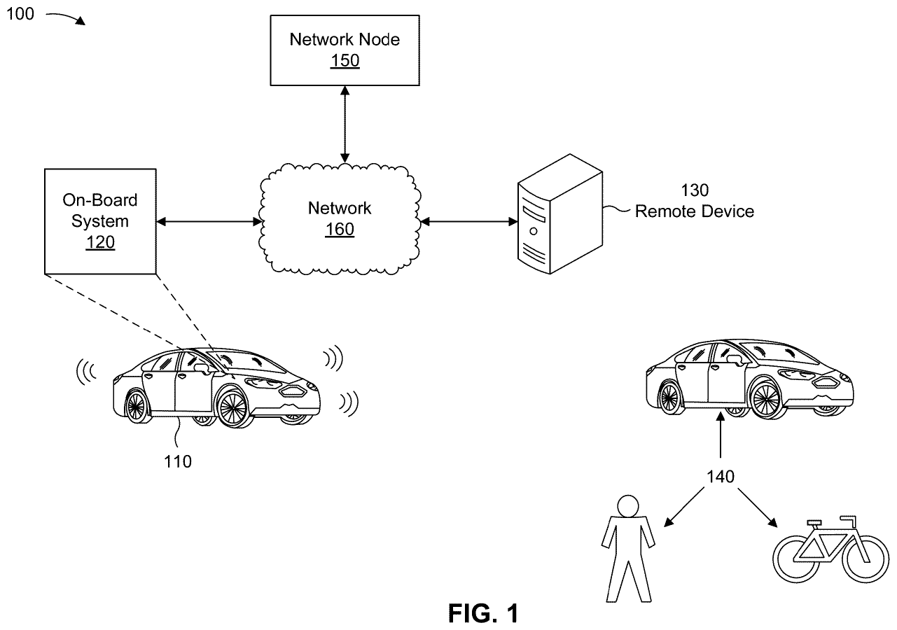

FIG. 1 is a diagram of an example environment 100 in which an autonomous vehicle or a vehicle equipped with an ADAS may operate. As shown in FIG. 1, the environment 100 may include, for example, a vehicle 110, an on-board system 120 of the vehicle 110, a remote device 130, a network node 150, and a network 160. Devices of the environment 100 may interconnect via wired connections, wireless connections, or a combination of wired and wireless connections. As further shown in FIG. 1, the environment 100 may include one or more objects 140 that the vehicle 110 is configured to detect (e.g., using the on-board system 120).

In some aspects, the vehicle 110 may include any moving form of conveyance that is capable of carrying one or more human occupants and/or cargo and that is powered by any suitable energy source. For example, the vehicle 110 may include a land vehicle (e.g., a car, a truck, a van, or a train), an aircraft (e.g., an unmanned aerial vehicle), and/or a watercraft. In the example depicted in FIG. 1, the vehicle 110 is a land vehicle, and is shown as a car. Furthermore, the vehicle 110 is an autonomous vehicle in the example of FIG. 1. For example, an autonomous vehicle (AV) is a vehicle having a processor, programming instructions, steering components, and drivetrain components that are controllable by the processor without requiring a human operator. An autonomous vehicle may be fully autonomous in that the autonomous vehicle does not require a human operator for most or all driving conditions and functions, or an autonomous vehicle may be semi-autonomous in that a human operator may be required in certain conditions or for certain operations, or that a human operator may override the autonomous system of the autonomous vehicle and take control of the autonomous vehicle. In some aspects, an autonomous vehicle (e.g., the vehicle 110) may support one or more DIL features. For example, the autonomous vehicle (e.g., the vehicle 110) may support one or more automated driving features (e.g., an automated steering feature and/or other automated features) that are subject to DIL control. Additionally, or alternatively, the vehicle 110 may be equipped with an ADAS that supports one or more safety features and/or technologies to help drivers avoid collisions and/or accidents (e.g., adaptive cruise control, lane departure warning, automatic emergency braking) or otherwise make driving the vehicle 110 safer and/or more efficient. In some aspects, an ADAS (e.g., the ADAS of the vehicle 110) may support one or more DIL features. For example, the ADAS may support one or more automated driving or driver assistance features (e.g., an automated or assisted steering feature and/or other automated or assisted features) that are subject to DIL control.

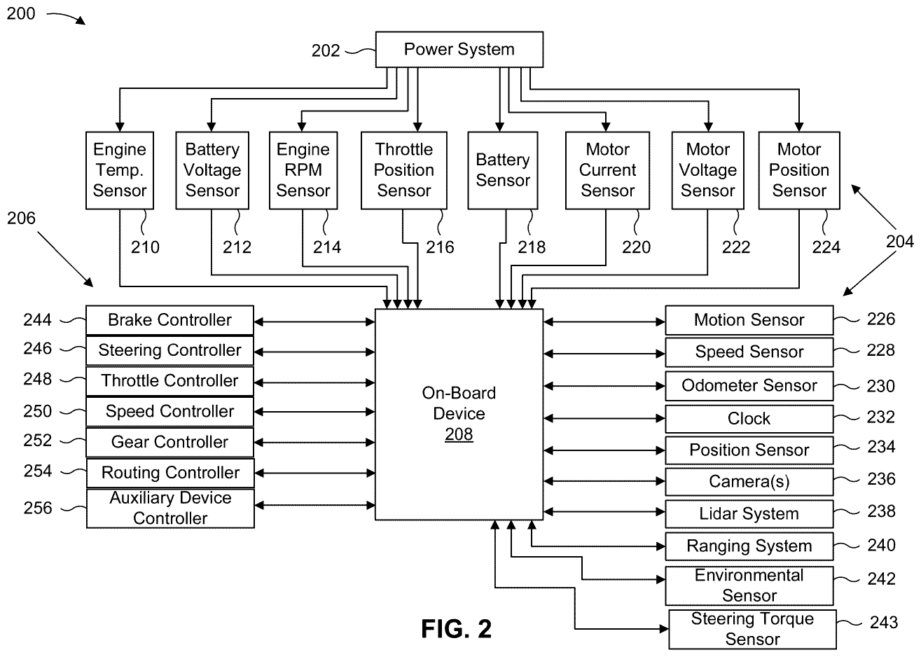

As shown in FIG. 1, the vehicle 110 may include an on-board system 120 that is integrated into and/or coupled with the vehicle 110. In general, the on-board system 120 may be used to control the vehicle 110, to sense information about the vehicle 110 and/or an environment in which the vehicle 110 operates, to detect one or more objects 140 in proximity of the vehicle, to provide output to or receive input from an occupant of the vehicle 110, and/or to communicate with one or more devices remote from the vehicle 110, such as another vehicle and/or the remote device 130. Accordingly, as described herein, the vehicle 110 may be an ego vehicle, which refers to the subject vehicle that is using autonomous driving technology, an ADAS, and/or one or more sensors (e.g., cameras, lidars, and radars) to perceive a surrounding environment and make decisions related to a trajectory, speed, and/or actions of the vehicle 110 on the road. The on-board system 120 is described in more detail below in connection with FIG. 2.

In some aspects, the vehicle 110 may travel along a road in a semi-autonomous or autonomous manner. The vehicle 110 may be configured to detect objects 140 in proximity of the vehicle 110. An object 140 may include, for example, another vehicle (e.g., an autonomous vehicle or a non-autonomous vehicle that requires a human operator for most or all driving conditions and functions), a cyclist (e.g., a rider of a bicycle, electric scooter, or motorcycle), a pedestrian, a road feature (e.g., a roadway boundary, a lane marker, a sidewalk, a median, a guard rail, a barricade, a sign, a traffic signal, a railroad crossing, or a bike path), and/or another object that may be on a roadway or in proximity of a roadway, such as a tree or an animal. In some aspects, to detect objects 140, the vehicle 110 may be equipped with a camera-based vision system and/or one or more sensors, such as a lidar system. In some aspects, the camera-based vision system and/or the one or more sensors may be included in another system other than the vehicle 110, such as a robot, a satellite, and/or a traffic light.

In some aspects, the one or more sensors may provide object detection data, such as information about a detected object 140 (e.g., information about a distance to the object 140, a speed of the object 140, and/or a direction of movement of the object 140) to one or more other components of the on-board system 120. Additionally, or alternatively, the vehicle 110 may transmit the object detection data to the remote device 130 (e.g., a server, a cloud computing system, and/or a database) via the network 160 (e.g., via the network node 150). The remote device 130 may be configured to process the object detection data and/or to transmit a result of processing the object detection data to the vehicle 110 via the network 160 (e.g., via the network node 150).

In some aspects, the network node 150 includes one or more devices configured to receive, generate, store, process, and/or provide information related to one or more aspects described herein. For example, the network node 150 may include a base station (a Node B, a gNB, and/or a 5G node B (NB), among other examples), a user equipment (UE), a roadside unit (RSU), a relay device, a network controller, an access point, a transmission reception point (TRP), an apparatus, a device, a computing system, and/or another suitable processing entity configured to perform one or more aspects described herein. For example, in some aspects, the network node 150 may include an aggregated base station and/or one or more components of a disaggregated base station (e.g., a central unit, a distributed unit, and/or a radio unit) that enables the on-board system 120 to communicate over the network 160 (e.g., to invoke or otherwise utilize processing capabilities associated with the remote device 130).

The network 160 includes one or more wired and/or wireless networks. For example, the network 160 may include a cellular network (e.g., a Long-Term Evolution (LTE) network, a code division multiple access (CDMA) network, a 3G network, a 4G network, a 5G network, another type of next generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks. In some aspects, the network 160 enables communication among the devices of environment 100. In some examples, the vehicle 110 (e.g., the on-board system 120) may communicate with one or more other devices (e.g., one or more other vehicles, the network node 150, and/or the remote device 130) via a vehicle-to-everything (V2X) protocol (or car-to-everything (C2X) protocol) (e.g., which may include a vehicle-to-vehicle (V2V) protocol (or car-to-car (C2 communications protocol), a vehicle-to-infrastructure (V2I) protocol, and/or a vehicle-to-pedestrian (V2P) protocol).

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

FIG. 2 is a diagram of an example on-board system 200 of an autonomous vehicle or a vehicle equipped with an ADAS. In some aspects, the on-board system 200 may correspond to the on-board system 120 included in the vehicle 110, as described above in connection with FIG. 1. As shown in FIG. 2, the on-board system 200 may include one or more of the illustrated components 202-256. The on-board system 200 may include, for example, a power subsystem 202, a sensor subsystem 204, a control subsystem 206, and/or an on-board device 208. The components of the on-board system 200 may communicate via a bus (e.g., one or more wired and/or wireless connections), such as a controller area network (CAN) bus.

The power subsystem 202 may be configured to generate mechanical energy for the vehicle 110 to move the vehicle 110. For example, the power subsystem 202 may include an engine that converts fuel to mechanical energy (e.g., via combustion) and/or a motor that converts electrical energy to mechanical energy.

The sensor subsystem 204 may include one or more sensors configured to detect operational parameters of the vehicle 110 and/or environmental conditions in an environment in which the vehicle 110 operates (e.g., surrounding the vehicle 110). For example, the sensor subsystem 204 may include an engine temperature sensor 210, a battery voltage sensor 212, an engine rotations per minute (RPM) sensor 214, a throttle position sensor 216, a battery sensor 218 (e.g., to measure current, voltage, and/or temperature of a battery), a motor current sensor 220, a motor voltage sensor 222, a motor position sensor 224 (e.g., a resolver and/or encoder), a motion sensor 226 (e.g., an accelerometer, gyroscope and/or inertial measurement unit), a speed sensor 228, an odometer sensor 230, a clock 232, a position sensor 234 (e.g., a global navigation satellite system (GNSS) sensor and/or a global positioning system (GPS) sensor), one or more cameras 236, a lidar system 238, one or more other ranging systems 240 (e.g., a radar system and/or a sonar system), an environmental sensor 242 (e.g., a precipitation sensor and/or ambient temperature sensor), and/or a steering torque sensor 243.

The control subsystem 206 may include one or more controllers configured to control operation of the vehicle 110. For example, the control subsystem 206 may include a brake controller 244 to control braking of the vehicle 110, a steering controller 246 to control steering and/or direction of the vehicle 110, a throttle controller 248 and/or a speed controller 250 to control speed and/or acceleration of the vehicle 110, a gear controller 252 to control gear shifting of the vehicle 110, a routing controller 254 to control navigation and/or routing of the vehicle 110 (e.g., using map data), and/or an auxiliary device controller 256 to control one or more auxiliary devices associated with the vehicle 110, such as a testing device, an auxiliary sensor, and/or a mobile device transported by the vehicle 110.

The on-board device 208 may be configured to receive sensor data from one or more sensors included in the sensor subsystem 204 and/or to provide commands to one or more controllers included in the control subsystem 206. For example, the on-board device 208 may control operation of the vehicle 110 by providing a command to a controller included in the control subsystem 206 based on sensor data received from a sensor included in the sensor subsystem 204. In some aspects, the on-board device 208 may be configured to process sensor data to generate a command. The on-board device 208 may include memory, one or more processors, an input component, an output component, and/or a communication component, as described elsewhere herein.

As an example, the on-board device 208 may receive navigation data, such as information associated with a navigation route from a start location of the vehicle 110 to a destination location for the vehicle 110. In some aspects, the navigation data is accessed and/or generated by the routing controller 254. For example, the routing controller 254 may access map data and identify possible routes and/or road segments that the vehicle 110 can travel to move from the start location to the destination location. In some aspects, the routing controller 254 may identify a preferred route, such as by scoring multiple possible routes, applying one or more routing techniques (e.g., minimum Euclidean distance, Dijkstra's algorithm, and/or Bellman-Ford algorithm), accounting for traffic data, and/or receiving a user selection of a route, among other examples. The on-board device 208 may use the navigation data to control operation of the vehicle 110. As the vehicle travels along the route, the on-board device 208 may receive sensor data from various sensors in the sensor subsystem 204. For example, the position sensor 234 may provide geographic location information to the on-board device 208, which may then access a map associated with the geographic location information to determine known fixed features associated with the geographic location, such as streets, buildings, stop signs, and/or traffic signals, which may be used to control operation of the vehicle 110.

In some aspects, the on-board device 208 may receive one or more images captured by one or more cameras 236, may analyze the one or more images (e.g., to detect object data), and may control operation of the vehicle 110 based on analyzing the images (e.g., to avoid detected objects). For example, the on-board device 208 may obtain, from the camera(s) 236, a series of images that depict a reference vehicle traveling along a road segment ahead of the vehicle 110, and the on-board device 208 may analyze the series of images to estimate a size of the reference vehicle and/or a position of the reference vehicle relative to the vehicle 110. The on-board device 208 may track a trajectory of the reference vehicle along the road segment ahead of the vehicle 110 based on the estimated size of the reference vehicle and/or the estimated position of the reference vehicle over the series of images and may estimate a surface geometry associated with the road segment ahead of the vehicle 110 based on the tracked trajectory of the reference vehicle. Accordingly, the on-board system 208 may generate one or more control signals (e.g., to control the vehicle 110, stay within a designated lane, avoid an obstacle, and/or plan a route) based on the estimated surface geometry associated with the road segment ahead of the vehicle 110.

In some aspects, the on-board device 208 may receive object data associated with one or more objects detected in a vicinity of the vehicle 110 and/or may generate object data based on sensor data. The object data may indicate the presence or absence of an object, a location of the object, a distance between the object and the vehicle 110, a speed of the object, a direction of movement of the object, an acceleration of the object, a trajectory (e.g., a heading) of the object, a shape of the object, a size of the object, a footprint of the object, and/or a type of the object (e.g., a vehicle, a pedestrian, a cyclist, a stationary object, or a moving object). The object data may be detected, for example, by one or more cameras 236 (e.g., as image data), the lidar system 238 (e.g., as lidar data) and/or one or more other ranging systems 240 (e.g., as radar data or sonar data). The on-board device 208 may process the object data to detect objects in proximity of the vehicle 110 and/or to control operation of the vehicle 110 based on the object data (e.g., to avoid detected objects).

In some aspects, the on-board device 208 may use the object data (e.g., current object data) to predict future object data for one or more objects. For example, the on-board device 208 may predict a future location of an object, a future distance between the object and the vehicle 110, a future speed of the object, a future direction of movement of the object, a future acceleration of the object, and/or a future trajectory (e.g., a future heading) of the object. For example, if an object is a vehicle and map data indicates that the vehicle is at an intersection, then the on-board device 208 may predict whether the object will likely move straight or turn. As another example, if the sensor data and/or the map data indicates that the intersection does not have a traffic light, then the on-board device 208 may predict whether the object will stop prior to entering the intersection.

The on-board device 208 may generate a motion plan for the vehicle 110 based on sensor data, navigation data, and/or object data (e.g., current object data and/or future object data). For example, based on current locations of objects and/or predicted future locations of objects, the on-board device 208 may generate a motion plan to move the vehicle 110 along a surface and avoid collision with other objects. In some aspects, the motion plan may include, for one or more points in time, a speed of the vehicle 110, a direction of the vehicle 110, and/or an acceleration of the vehicle 110. Additionally, or alternatively, the motion plan may indicate one or more actions with respect to a detected object, such as whether to overtake the object, yield to the object, pass the object, or the like. The on-board device 208 may generate one or more commands or instructions based on the motion plan, and may provide those command(s) to one or more controllers associated with the control subsystem 206 for execution.

In some aspects, an automated driving or driver assistance feature supported by the on-board system 200 may subject to DIL control. In such examples, the on-board device 208 may transfer control of the vehicle associated with the automated driving or driver assistance feature (e.g., an ADAS feature) and the driver of the vehicle based on the on-board device 208 determining whether the driver is actively interacting with the vehicle. In some aspects, the on-board device 208 may detect a driver interaction based on measured torque on a steering column (e.g., steering wheel torque values measured by the steering torque sensor 243), and the on-board device 208, in connection with detecting the driver interaction, may transition control of the vehicle from an ADAS feature to the driver by outputting, to the steering controller 246, a steering request that transitions from a feature steering request associated with the ADAS feature to a driver steering request. The steering request output from the on-board device 208 to the steering controller 246 may be a pinion angle request or a curvature request. In some aspects, the on-board device 208, in connection with detecting a lack of driver interaction (e.g., based on steering wheel torque values measured by the steering torque sensor 243), may transition control of the vehicle from the driver to an ADAS feature by outputting a steering request that transitions from a driver steering request to a feature steering request associated with the ADAS feature.

As indicated above, FIG. 2 is provided as an example. Other examples may differ from what is described with regard to FIG. 2. The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more functions described as being performed by another set of components shown in FIG. 2. For example, although some components of FIG. 2 are primarily associated with land vehicles, other types of vehicles are within the scope of the disclosure.

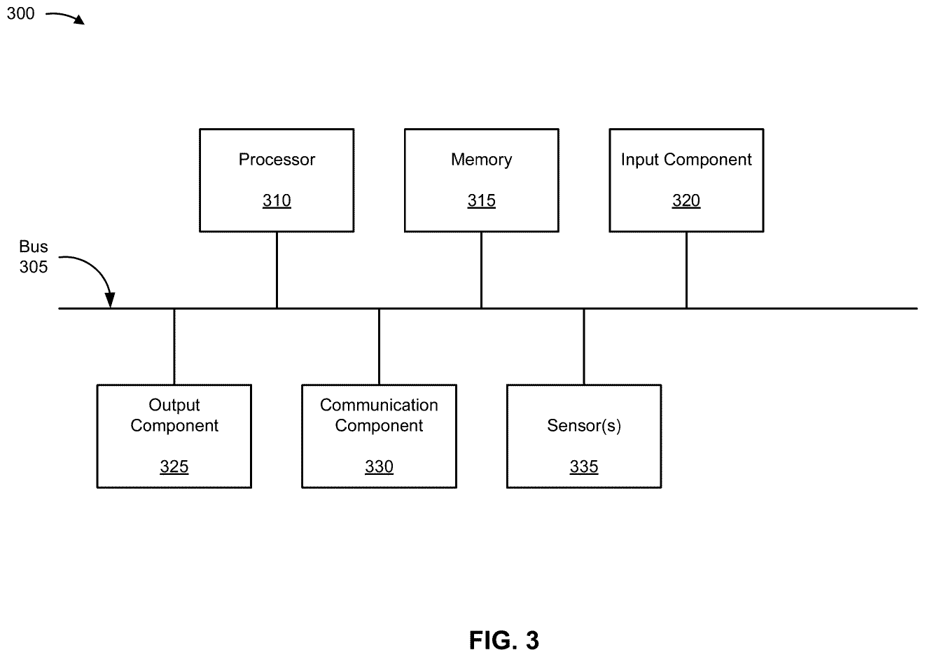

FIG. 3 is a diagram illustrating example components of a device 300. The device 300 may correspond to the on-board system 120, the remote device 130, or the network node 150 depicted in FIG. 1, the on-board system 200 or the on-board device 208 depicted in FIG. 2, and/or any other device, system, subsystem, or component described herein. In some aspects, the on-board system 120, the remote device 130, the network node 150, the on-board system 200, the on-board device 208, and/or other devices, systems, subsystems, or components described herein may include one or more devices 300 and/or one or more components of the device 300. As shown in FIG. 3, the device 300 may include a bus 305, a processor 310, a memory 315, an input component 320, an output component 325, a communication component 330, and/or one or more sensor(s).

The bus 305 may include one or more components that enable wired or wireless communication among the components of the device 300. The bus 305 may couple together two or more components of FIG. 3, such as via operative coupling, communicative coupling, electronic coupling, or electric coupling. For example, the bus 305 may include an electrical connection (e.g., a wire, a trace, or a lead) or a wireless bus. The processor 310 may include a central processing unit, a graphics processing unit, a microprocessor, a controller, a microcontroller, a digital signal processor, a field-programmable gate array, an application-specific integrated circuit, or another type of processing component. The processor 310 may be implemented in hardware, firmware, or a combination of hardware and software. In some aspects, the processor 310 may include one or more processors capable of being programmed to perform one or more operations or processes described elsewhere herein.

The memory 315 may include volatile or nonvolatile memory. For example, the memory 315 may include random access memory (RAM), read only memory (ROM), a hard disk drive, or another type of memory (e.g., a flash memory, a magnetic memory, or an optical memory). The memory 315 may include internal memory (e.g., RAM, ROM, or a hard disk drive) or removable memory (e.g., removable via a universal serial bus connection). The memory 315 may be a non-transitory computer-readable medium. The memory 315 may store information, one or more instructions, or software (e.g., one or more software applications) related to the operation of the device 300. In some aspects, the memory 315 may include one or more memories that are coupled (e.g., communicatively coupled) to one or more processors (e.g., processor 310), such as via the bus 305. Communicative coupling between a processor 310 and a memory 315 may enable the processor 310 to read or process information stored in the memory 315 or to store information in the memory 315.

The input component 320 may enable the device 300 to receive input, such as user input or sensed input. For example, the input component 320 may include a touch screen, a keyboard, a keypad, a mouse, a button, a microphone, a switch, a sensor, a global positioning system sensor, a global navigation satellite system sensor, an accelerometer, a gyroscope, or an actuator. The output component 325 may enable the device 300 to provide output, such as via a display, a speaker, or a light-emitting diode. The communication component 330 may enable the device 300 to communicate with other devices via a wired connection or a wireless connection. For example, the communication component 330 may include a receiver, a transmitter, a transceiver, a modem, a network interface card, or an antenna.

The sensor 335 includes one or more devices capable of detecting a characteristic associated with the device 300 (e.g., a characteristic relating to a physical environment of the device 300 or a characteristic relating to a condition of the device 300). The sensor 335 may include one or more photodetectors (e.g., one or more photodiodes), one or more cameras, one or more microphones, one or more gyroscopes (e.g., a micro-electro-mechanical system (MEMS) gyroscope), one or more magnetometers, one or more accelerometers, one or more location sensors (e.g., a GPS receiver or a local position system (LPS) device), one or more motion sensors, one or more temperature sensors, one or more pressure sensors, and/or one or more touch sensors, among other examples.

The device 300 may perform one or more operations or processes described herein. For example, a non-transitory computer-readable medium (e.g., memory 315) may store a set of instructions (e.g., one or more instructions or code) for execution by the processor 310. The processor 310 may execute the set of instructions to perform one or more operations or processes described herein. In some aspects, execution of the set of instructions, by one or more processors 310, causes the one or more processors 310 or the device 300 to perform one or more operations or processes described herein. In some aspects, hardwired circuitry may be used instead of or in combination with the instructions to perform one or more operations or processes described herein. Additionally, or alternatively, the processor 310 may be configured to perform one or more operations or processes described herein. Thus, aspects described herein are not limited to any specific combination of hardware circuitry and software.

In some aspects, device 300 may include means for detecting a driver interaction based on measured torque on a steering column of the vehicle; and/or means for transitioning, in connection with detecting the driver interaction, control of the vehicle from an ADAS feature to a driver by outputting a steering request that transitions from a feature steering request associated with the ADAS feature to a driver steering request. In some aspects, the means for device 300 to perform processes and/or operations described herein may include one or more components of device 300 described in connection with FIG. 3, such as bus 305, processor 310, memory 315, input component 320, output component 325, communication component 330, and/or sensor(s) 335.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

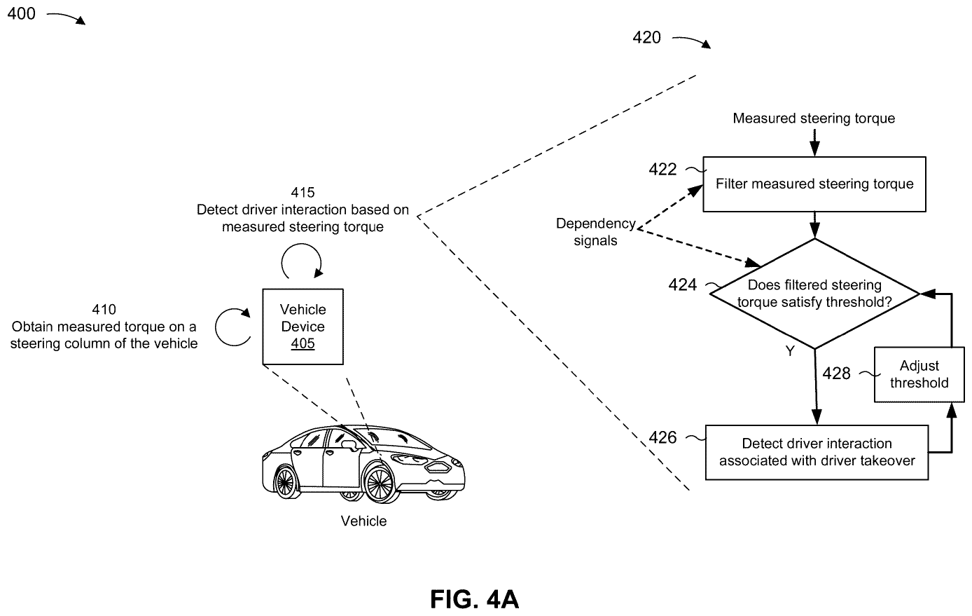

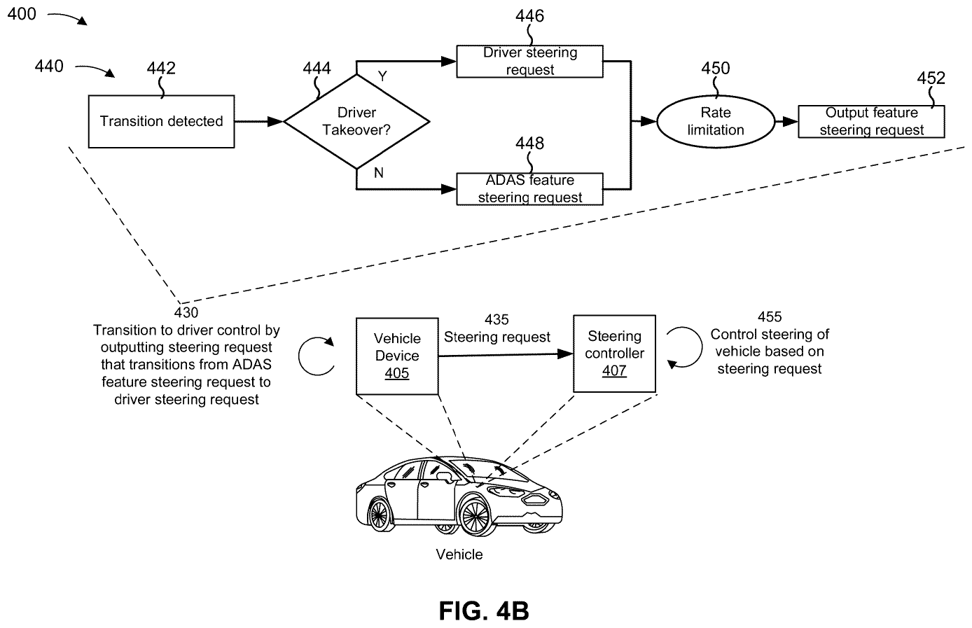

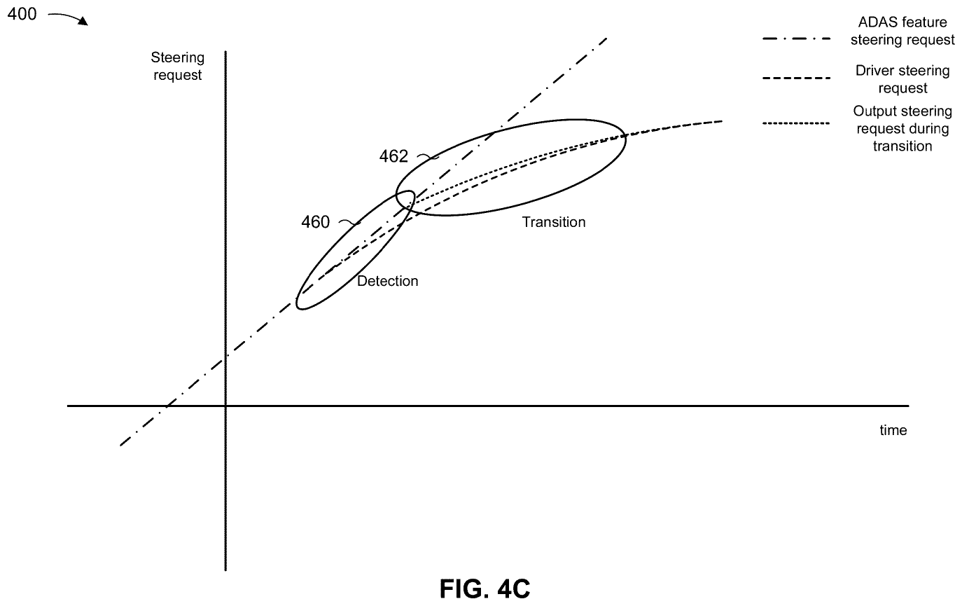

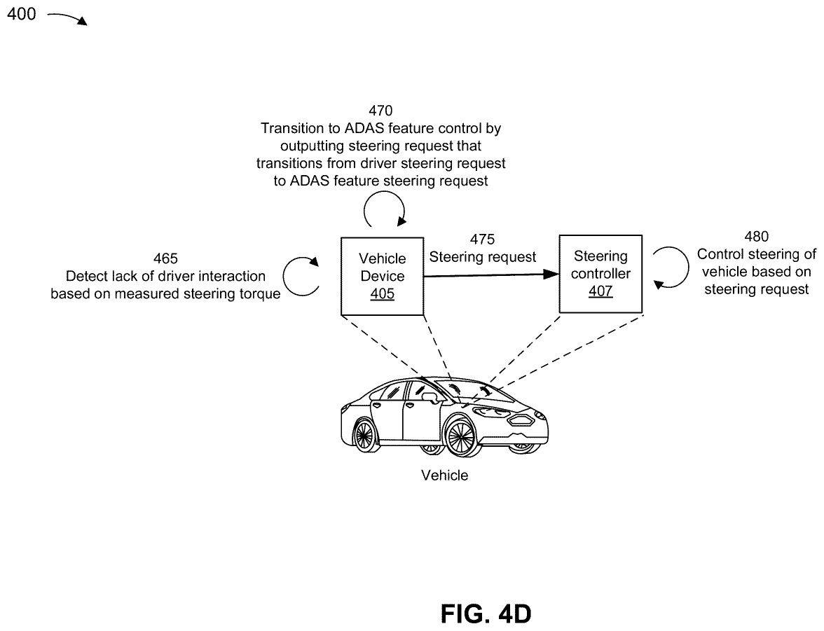

FIGS. 4A-4D are diagrams illustrating an example 400 associated with a steering request for DIL vehicle control. As shown in FIGS. 4A-4B, example 400 includes a vehicle (e.g., vehicle 110), a vehicle device 405, and a steering controller 407 (e.g., steering controller 246) of the vehicle. The vehicle may be an autonomous driving vehicle or a vehicle equipped with an ADAS. For example, the vehicle may be equipped with an on-board system (e.g., on-board system 120 and/or on-board system 200) that supports autonomous driving and/or ADAS technology. The vehicle device 405 may be a device associated with the vehicle. In some aspects, the vehicle device 405 may be an on-board device (e.g., on-board device 208) of an on-board system (e.g., on-board system 120 and/or on-board system 200) of the vehicle. For example, the vehicle device 405 may be an on-board device (e.g., on-board device 208) associated with an ADAS of the vehicle. In some aspects, the steering controller 407 may be a steering ECU.

As shown in FIG. 4A, and by reference number 410, the vehicle device 405 may obtain measured torque on a steering column of the vehicle. The measured torque may include measurements of torque on the steering column of the vehicle (also referred to herein as “steering torque”). The vehicle device 405 may obtain the measured torque from a sensor (e.g., steering torque sensor 243) of the vehicle. The sensor may measure the steering torque (e.g., the torque on the steering column of the vehicle) and transmit a steering torque signal including the steering torque measurements to the vehicle device 405. In some examples, the sensor may continuously or periodically measure the steering torque. Accordingly, the steering torque signal obtained/received by the vehicle device 405 may include continuous steering torque measurements over time or a series of discrete steering torque measurements measured at a certain time interval. The steering torque signal may be a signal available to the vehicle device 405 in an ADAS stack associated with the vehicle device 405.

In some aspects, the vehicle device 405 may obtain the measured steering torque (e.g., the steering torque signal) when an ADAS feature is controlling the vehicle. For example, the ADAS feature may be controlling the steering of the vehicle, as well as the speed of the vehicle and/or other operating parameters of the vehicle. While the ADAS feature is controlling the vehicle, the vehicle device 405 may output, to the steering controller 407 (shown in FIG. 4B), an ADAS feature steering request. The ADAS feature steering request is a steering request associated with the ADAS feature that is controlling the vehicle. In some examples, the ADAS feature steering request may be a pinion angle request. For example, the pinion angle request may be a signal (e.g., a pinion angle request signal) indicating requested pinion angles for the vehicle. In some other examples, the ADAS feature steering request may be a curvature request. For example, the curvature request may be a signal (e.g., a curvature request signal) requesting that the vehicle be steered in accordance with a certain curvature. The steering controller 407 may steer the vehicle in accordance with the ADAS feature steering request. For example, the steering controller 407 may determine a torque to apply to the steering column to steer the vehicle in accordance with the ADAS feature steering request (e.g., the pinion angle request or the curvature request). In some aspects, the vehicle device 405 may continue to obtain the measured steering torque (e.g., the steering torque signal) after the vehicle device 405 detects a driver interaction and transitions control of the vehicle from the ADAS feature to the driver, as described in greater detail below.

As further shown in FIG. 4A, and by reference number 415, the vehicle device 405 may detect driver interaction based on the measured steering torque. The vehicle device 405 may detect the driver interaction when an ADAS feature is controlling the vehicle (e.g., when the vehicle device 405 is outputting, to the steering controller 407, the ADAS feature steering request). The driver interaction may be indicative of a driver actively interacting with a steering wheel of the vehicle. That is, the vehicle device 405 may detect, based on the measured steering torque, a driver interaction associated with a driver takeover of control of the vehicle from the ADAS feature.

FIG. 4A shows an example 420 of the vehicle device 405 detecting the driver interaction based on the measured steering torque. As shown by reference number 422, the vehicle device 405 may filter the measured steering torque (e.g., the measured steering torque signal). The vehicle device 405 may filter the measured steering torque to recognize or isolate torque applied to the steering column of the vehicle by the driver. The filtering of the measured steering torque signal may enable quick recognition of steering torque applied by the driver while reducing false positives (e.g., driver interactions detected based on steering torque not applied by the driver). In some aspects, the vehicle device 405 may apply low pass filtering, high pass filtering, or both low pass filtering and high pass filtering to the measured steering torque to shrink the measure torque band to within a range of torque and torque rate applied by humans on the steering system. In some aspects, the vehicle device 405 may filter the measured steering torque using a second order Butterworth low pass filter. In some aspects, the vehicle device 405 may filter the measured steering torque by applying a compensator, such as a lead-lag compensator, to the measured steering torque signal.

As shown in FIG. 4A, in some examples, the vehicle device 405 may filter the measured steering torque based at least in part on one or more dependency signals. For example, the dependency signals may be signals received from one or more sensors (e.g., one or more sensors other than the steering torque sensor) and/or signals associated with one or more actuators (e.g., one or more actuator requests). In some aspects, the vehicle device 405 may filter the measured steering torque based on disturbances associated with sensor data of the vehicle or actuator responses of the vehicle. For example, the vehicle device 405 may filter the measured steering torque with a compensator designed to filter out known disturbances. “Known disturbances” refers to disturbances, affecting the measured steering torque, that can be measured or detected by one or more other sensors (e.g., sensors other than the steering torque sensor) or correspond to the response/movement of one or more actuators associated with one or more actuator requests. In some examples, the compensator may filter out, from the measured steering torque, applied actuations (e.g., actuator responses), such as the vibration of a haptic warning or applied feature torque associated with the ADAS feature (e.g., applied by the steering controller 407 in connection with the ADAS feature steering request). Additionally, or alternatively, in some examples, the compensator may filter out measured steering torque due to vehicle movements, such as due to a bump in the road or the vehicle being in a curve. For example, the bump in the road may also be measured by pitch and yaw movements of the vehicle, or the active suspension may measure the bump directly. A road irregularity (e.g., a bump or another irregularity) may also be measured or detected by a front camera of a lidar or radar system of the vehicle. In addition, a curve may be detected by the vehicle movement, the front camera, or the ADAS feature request (e.g., a curvature request or a pinion angle request).

In some aspects, the vehicle device 405 may filter the measured steering torque using a Kalman filter to estimate a state of driver interaction. In such examples, sensor and actuator input (e.g., signals received from one or more sensors and/or associated with one or more actuators), such as the examples described above in associated with the known disturbances, may be fused and fed as input to a predictive part of the Kalman filter. In some aspects, the different sensor and actuator signals may also be linked to a machine learning model that is trained to recognize non-driver-triggered steering torque changes. Additionally, or alternatively, the machine learning model may be trained to recognize driver inputs (e.g., steering torque changes applied by the driver) based on steering torque data obtained when the driver is manually driving the vehicle without any active ADAS features.

In some aspects, the vehicle device 405 may perform the filtering of the measured steering torque using any combination of the filtering techniques described herein. The filtering of the measured steering torque results in a filtered measured steering torque (e.g., a filtered measured steering torque signal). By filtering the measured steering torque, the resulting filtered measured steering torque signal may be tailored to be a more driver-specific signal.

As shown by reference number 424, the vehicle device 405 may evaluate the filtered measured steering torque (e.g., the filtered measured steering torque signal) to determine whether the filtered measured steering torque satisfies a threshold. For example, the threshold may be a threshold for a driver takeover of control of the vehicle from an ADAS feature. In some examples, the filtered measured steering torque may satisfy the threshold (e.g., the threshold for a driver takeover) if the filtered measured steering torque is greater than the threshold. The threshold may distinguish passive driver interaction (e.g., due to the driver resting a hand on the steering wheel) from active driver interaction associated with a driver taking control of the vehicle. As shown in FIG. 4A, in some examples, the threshold may be based at least in part on one or more dependency signals. For example, the threshold may be based at least in part on a speed of the vehicle or another operating parameter of the vehicle.

As shown by reference number 426, if the filtered measured steering torque satisfies the threshold, the vehicle device 405 may detect a driver interaction associated with a driver takeover of control of the vehicle from the ADAS feature. As shown by reference number 428, when the vehicle device 405 detects the driver interaction associated with the driver takeover (e.g., when the filtered measured steering torque satisfies the threshold), the vehicle device 405 may adjust the threshold. For example, the vehicle device 405 may lower the threshold from a first threshold used for detection of a driver interaction associated with a driver takeover of vehicle control from an ADAS feature to a second threshold for detection of lack of driver interaction associated with the ADAS feature resuming control of the vehicle. Adjusting the threshold from the first threshold to the second threshold that is lower than the first threshold may increase stability of the driver takeover by preventing toggling between ADAS feature control and driver control due to hysteresis.

As shown in FIG. 4B, and by reference number 430, the vehicle device 405, in connection with detecting the driver interaction, may transition control of the vehicle from an ADAS feature to the driver by outputting a steering request that transitions from an ADAS feature steering request (e.g., a feature steering request associated with the ADAS feature) to a driver steering request. As shown by reference 435, the vehicle device 405 may output (e.g., transmit) the driver steering request to the steering controller 407. That is, in connection with detecting the driver interaction, the vehicle device 405 may adjust the output steering request transmitted to the steering controller from the ADAS feature request being output by the vehicle device 405 prior to detection of the driver interaction to a feature steering request that transitions from the ADAS feature request to a driver steering request determined based on the measured steering torque. In this way, the feature steering request output by the vehicle device 405 may transition to, and eventually mirror, the driver steering request such that the driver does not have to fight with the output feature request for control of the vehicle. In some aspects, the steering request output by the vehicle device 405 (e.g., the feature steering request) may transition from the ADAS feature steering request to the driver steering request in accordance with a rate limitation that controls the rate of change of the steering request. In this way, a smooth transition from the ADAS feature steering request to the driver steering request may be ensured.

In some aspects, the vehicle device 405 may not cancel the ADAS feature when the vehicle device 405 transitions control of the vehicle from the ADAS feature to the driver. The vehicle device 405 may continue to calculate the ADAS feature steering request while outputting the feature steering request that transitions to, and eventually mirrors, the driver steering request to enable a seamless transition back to control of the vehicle by the ADAS feature (e.g., without the driver having to activate the ADAS feature again) when the driver stops interacting with the steering wheel of the vehicle.

FIG. 4B shows an example 440 of the vehicle device 405 outputting a feature steering request that transitions from an ADAS feature steering request to a driver steering request. As shown by reference number 442, the vehicle device 405 may detect a transition of control of the vehicle. For example, the vehicle device 405 may detect the driver interaction associated with the driver takeover of vehicle control from an ADAS feature, as described above in connection with FIG. 4A. Alternatively, the vehicle device 405 may detect a takeover of control of the vehicle by the ADAS feature (e.g., due to a lack of driver interaction). As shown by reference number 444, the vehicle device 405 may determine whether the transition is a driver takeover of control of the vehicle from the ADAS feature.

As shown by reference number 446, if the transition is the driver takeover, the vehicle device 405 may identify the driver steering request as the target signal for the feature steering request output, to the steering controller 407, by the vehicle device 405. In this case, the vehicle device 405 may apply a switch for the output feature steering request to mirror the driver steering request. The vehicle device 405 may determine the driver steering request based on the measured steering torque. Once the driver takeover is detected, the vehicle device 405 may adjust the output feature steering request to transition to, and then mirror or match, a steering request signal that is equal to or at least close to (e.g., within an error threshold) what the driver is requesting (e.g., the driver steering request). The external (e.g., to the ADAS) steering torque control (e.g., the steering controller 407) may calculate the torque to be applied to steer the vehicle based on the driver input and the feature torque. The feature torque may cover the difference between the driver steering request and the feature steering request output by the vehicle device 405. By having the same or a similar steering request for both the driver steering request and the feature steering request, the difference between the driver steering request and the feature steering request may be zero or small. As a result, zero or a small amount of additional feature torque will result from the feature steering request (e.g., there will be no or a small amount of torque that the driver is fighting against after taking over) once the output feature steering request transitions to mirror the driver steering request.

As shown by reference number 448, if the transition is not the driver takeover (e.g., the transition is a return of control of the vehicle to the ADAS feature), the vehicle device 405 may identify the ADAS feature steering request and the target signal for the feature steering request output, to the steering controller 407, by the vehicle device 405. The vehicle device 405 may continue to calculate the ADAS feature steering request (e.g., the feature steering request associated with the ADAS feature) when the vehicle device 405 transitions control of the vehicle from the ADAS feature to the driver, in order to enable a transition back to the control by the ADAS feature once the driver has stopped interacting with the steering wheel of the vehicle. In this case, the vehicle device 405 may output a feature steering request that transitions from the driver steering request to the ADAS feature steering request.

As shown by reference number 450, the vehicle device 405 may apply a rate limitation to the transition of the output feature steering request to mirror the target signal. The rate limitation may limit the rate of change of the feature steering request output by the vehicle device 405. In a case in which the driver takeover is detected, the vehicle device 405 may apply the rate limitation to the transition of the output feature steering request from the ADAS feature steering request to the driver steering request. The rate limitation may ensure a smooth transition, and thus increase safety and a more comfortable user experience, when switching between the ADAS feature steering request and the driver steering request. Additionally, or alternatively, a transition model or curve may be applied to the transition of the output feature steering request from the ADAS feature steering request to the driver steering request. In some aspects, the rate limitation may be a linear rate limitation. In such examples, the rate limitation may smoothen sudden steps (which result in uncomfortable and possibly unsafe steering jerks) and high rate changes. An advantage of a linear rate limitation is ease of tuneability, due to the linear rate limitation only having one parameter. In some aspects, the rate limitation may be a higher order rate limitation. Such a higher order rate limitation may provide a more seamless transition between the ADAS feature steering request and the driver steering request (or vice versa). In some examples, the rate limitation may be associated with a Gaussian distribution. In some other examples, transition between the ADAS feature steering request and the driver steering request (or vice versa) may be in accordance with a hyperbolic tangent (e.g., tangens hyperbolicus) function.

As shown by reference number 452, the vehicle device 405 may output the feature steering request that transitions from the ADAS feature steering request to the driver steering request (or vice versa) in accordance with the rate limitation or in accordance with a transition model or curve applied to the transition. For example, the vehicle device 405 may output, to the steering controller 407, the feature steering request that transitions from the ADAS feature steering request to the driver steering request (or vice versa) in accordance with the rate limitation or in accordance with a transition model or curve applied to the transition.

As further shown in FIG. 4B, and by reference number 455, the steering controller 407 may control steering of the vehicle based on the steering request (e.g., the feature steering request) output by the vehicle device 405. The steering controller 407 may receive the output feature steering request (e.g., pinion angle request or curvature request) from the vehicle device 405, and the steering controller 407 may calculate the torque to be applied to steer (e.g., control lateral movement of) the vehicle based on the driver input and the feature steering request. The steering controller 407 may control an actuator to apply the torque to steer the vehicle.

In some cases, due to a delay between the feature steering request (e.g., pinion angle request or curvature request) output by the vehicle device 405 (e.g., output from an ADAS stack of the vehicle device 405) and the actuator response controlled by the steering controller 407, the output feature steering request may never exactly equal the measured driver steering request. As a result, there may be a continuous small feature torque being applied by the steering controller 407 to try to “correct” the actual driver input to the feature steering request, which lags behind the driver input by an amount of time equal to the delay. In some aspects, the vehicle device 405 may extrapolate the driver steering request over an amount of time corresponding to a delay between outputting the feature steering request and an actuator response to steer the vehicle based on the feature steering request. That is, the vehicle device 405 may extrapolate the actual measured driver steering request to predict what the driver steering request will be after the amount of time corresponding to the delay. In such examples, the feature steering request output by the vehicle device 405 may transition from the ADAS feature steering request to the extrapolated driver steering request, and eventually mirror/match the extrapolated driver steering request. By extrapolating the driver steering request over the amount of time of the delay, the delay may be reduced and the vehicle device 405 may mitigate feature torque applied by the steering controller 407 due to the delay. In some aspects, the extrapolation of the driver steering request may be a linear extrapolation. In some other aspects, the extrapolation of the driver steering request may be a second order extrapolation based on a rate of the driver steering request.

FIG. 4C shows an example of steering request signals associated with a detection of a driver interaction associated with a driver takeover (shown by reference number 460) and a transition of control of the vehicle from an ADAS feature to the driver (shown by reference number 462). The steering request signals shown in FIG. 4C include an ADAS feature steering request signal, a driver steering request signal, and an output steering request signal during the transition. In some aspects, the steering request signals may be pinion angle request signals or curvature request signals. As shown in FIG. 4C, prior to the detection of the driver interaction, the vehicle device 405 outputs, to the steering controller 407, the ADAS feature steering request. As further shown in FIG. 4C, during the transition of control of the vehicle from the ADAS feature to the driver, the steering request (e.g., feature steering request) output by the vehicle device 405 transitions from the ADAS feature steering request to the driver steering request. In this example, during the transition, the steering request (e.g., feature steering request) output by the vehicle device 405 transitions from the ADAS feature steering request to the driver steering request in accordance with a rate limitation.

As shown in FIG. 4D, and by reference number 465, the vehicle device 405 may detect a lack of driver interaction based on the measured steering torque. As described above, the vehicle device 405 may continue obtaining (e.g., from a sensor) the measured steering torque after the vehicle device 405 detects the driver takeover and transitions control of the vehicle to the driver. The vehicle device 405 may filter the measured steering torque, as described above in connection with FIG. 4A, resulting in the filtered measured steering torque. The vehicle device 405 may compare the filtered measured steering torque to a threshold. For example, the vehicle device 405 may compare the filtered measured steering torque to a threshold associated with detecting a return to control of the vehicle by an ADAS feature due to a lack of driver interaction. In this case, the threshold may be a second threshold that is less than a first threshold for detecting the driver takeover. In some examples, the filtered measured torque may satisfy the threshold for detecting the return to control of the vehicle by the ADAS feature if the filtered measured torque is less than the threshold. The vehicle device 405 may detect the lack of driver interaction in connection with determining that the filtered measured torque satisfies the threshold.

As shown by reference number 470, the vehicle device 405 may transition control of the vehicle from the driver to the ADAS feature by outputting a steering request that transitions from the driver steering request to the ADAS steering request. The vehicle device 405 may output the steering request (e.g., a feature steering request) that transitions from the driver steering request to the ADAS steering request similarly to as described above in connection with FIG. 4B for a steering request that transitions from the ADAS feature steering request to the driver steering request. In some aspects, the steering request (e.g., feature steering request) output by the vehicle device 405 may transition from the driver steering request to the ADAS feature steering request in accordance with a rate limitation. The vehicle device 405 may apply the rate limitation similarly to as described above in connection with FIG. 4B. In some examples, the steering request output by the vehicle device 405 may be a pinion angle request. In some examples, the steering request output by the vehicle device 405 may be a curvature request.

As shown by reference number 475, the vehicle device 405 may output (e.g., transmit), to the steering controller 407, the steering request (e.g., the feature steering angle request) that transitions from the driver steering request to the ADAS feature steering request. The steering controller 407 may receive the steering request (e.g., the feature steering angle request) output by the vehicle device 405.

As shown by reference number 480, the steering controller 407 may control steering of the vehicle based on the steering request (e.g., the feature steering request) output by the vehicle device 405. The steering controller 407 may calculate the torque to be applied to steer (e.g., control lateral movement of) the vehicle based on the feature steering request received from the vehicle device 405. The steering controller 407 may control an actuator to apply the torque to steer the vehicle.

As indicated above, FIGS. 4A-4D are provided as an example. Other examples may differ from what is described with respect to FIGS. 4A-4D.

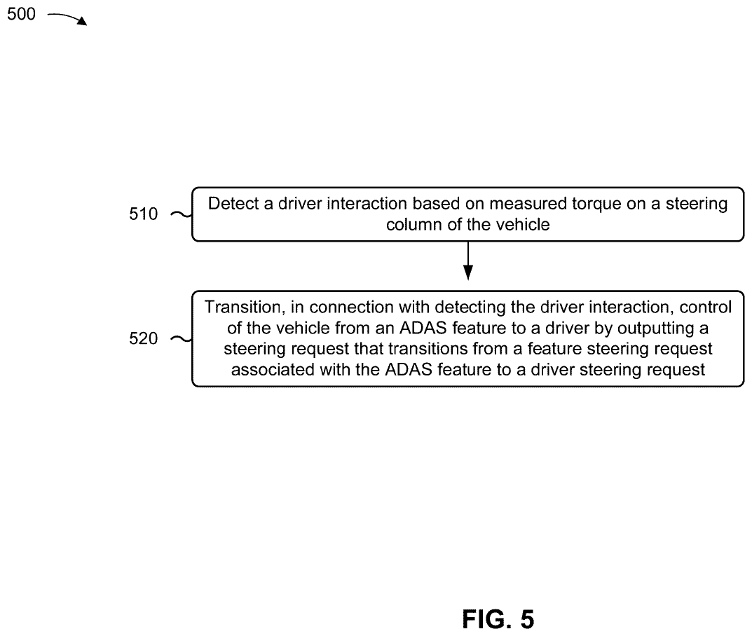

FIG. 5 is a flowchart of an example process 500 associated with a steering request for DIL vehicle control. In some aspects, one or more process blocks of FIG. 5 are performed by a device (e.g., vehicle device 405, on-board device 208, or on-board system 120). In some aspects, one or more process blocks of FIG. 5 are performed by another device or a group of devices separate from or including the device, such as a remote device (e.g., remote device 130), and/or a network node (e.g., network node 150). Additionally, or alternatively, one or more process blocks of FIG. 5 may be performed by one or more components of device 300, such as processor 310, memory 315, input component 320, output component 325, communication component 330, and/or sensor 335.

As shown in FIG. 5, process 500 may include detecting a driver interaction based on measured torque on a steering column of the vehicle (block 510). For example, the device may detect a driver interaction based on measured torque on a steering column of the vehicle, as described above.

As further shown in FIG. 5, process 500 may include transitioning, in connection with detecting the driver interaction, control of the vehicle from an ADAS feature to a driver by outputting a steering request that transitions from a feature steering request associated with the ADAS feature to a driver steering request (block 520). For example, the device may transition, in connection with detecting the driver interaction, control of the vehicle from an ADAS feature to a driver by outputting a steering request that transitions from a feature steering request associated with the ADAS feature to a driver steering request, as described above.

Process 500 may include additional aspects, such as any single aspect or any combination of aspects described below and/or in connection with one or more other processes described elsewhere herein.

In a first aspect, detecting the driver interaction includes filtering the measured torque, resulting in a filtered measured torque associated with the driver interaction, and detecting the driver interaction based on a comparison of the filtered measured torque to a threshold.

In a second aspect, alone or in combination with the first aspect, filtering the measured torque includes filtering the measured torque using at least one of a low pass filter, a high pass filter, a lead-lag compensator, or a Kalman filter.

In a third aspect, alone or in combination with one or more of the first and second aspects, filtering the measured torque includes filtering the measured torque based on disturbances associated with sensor data of the vehicle or actuator responses of the vehicle.

In a fourth aspect, alone or in combination with one or more of the first through third aspects, the steering request transitions from the feature steering request associated with the ADAS feature to the driver steering request in accordance with a rate limitation.

In a fifth aspect, alone or in combination with one or more of the first through fourth aspects, the rate limitation is linear.

In a sixth aspect, alone or in combination with one or more of the first through fifth aspects, the rate limitation is associated with a Gaussian distribution, or the steering request transitions from the feature steering request associated with the ADAS feature to the driver steering request in accordance with a hyperbolic tangent function.

In a seventh aspect, alone or in combination with one or more of the first through sixth aspects, process 500 includes extrapolating the driver steering request over an amount of time corresponding to a delay between outputting the steering request and an actuator response to steer the vehicle based on the steering request, wherein the steering request transitions from the feature steering request to the extrapolated driver steering request.

In an eighth aspect, alone or in combination with one or more of the first through seventh aspects, the extrapolation of the driver steering request is linear.

In a ninth aspect, alone or in combination with one or more of the first through eighth aspects, the extrapolation of the driver steering request is second order based on a rate of the driver steering request.

In a tenth aspect, alone or in combination with one or more of the first through ninth aspects, the steering request is a pinion angle request.

In an eleventh aspect, alone or in combination with one or more of the first through tenth aspects, the steering request is a curvature request.

In a twelfth aspect, alone or in combination with one or more of the first through eleventh aspects, process 500 includes detecting a lack of driver interaction based on subsequent measured torque on the steering column, and transitioning, in connection with detecting the lack of driver interaction, control of the vehicle from the driver to the ADAS feature by outputting a subsequent steering request that transitions from the driver steering request to the feature steering request associated with the ADAS feature.

In a thirteenth aspect, alone or in combination with one or more of the first through twelfth aspects, the subsequent steering request transitions from the driver steering request to the feature steering request associated with the ADAS feature in accordance with a rate limitation.

Although FIG. 5 shows example blocks of process 500, in some aspects, process 500 includes additional blocks, fewer blocks, different blocks, or differently arranged blocks than those depicted in FIG. 5. Additionally, or alternatively, two or more of the blocks of process 500 may be performed in parallel.

The following provides an overview of some Aspects of the present disclosure:
Aspect 1: A method performed by a device associated with a vehicle, comprising: detecting a driver interaction based on measured torque on a steering column of the vehicle; and transitioning, in connection with detecting the driver interaction, control of the vehicle from an advanced driver assistance system (ADAS) feature to a driver by outputting a steering request that transitions from a feature steering request associated with the ADAS feature to a driver steering request.
Aspect 2: The method of Aspect 1, wherein detecting the driver interaction comprises: filtering the measured torque, resulting in a filtered measured torque associated with the driver interaction; and detecting the driver interaction based on a comparison of the filtered measured torque to a threshold.
Aspect 3: The method of Aspect 2, wherein filtering the measured torque comprises: filtering the measured torque using at least one of a low pass filter, a high pass filter, a lead-lag compensator, or a Kalman filter.
Aspect 4: The method of any of Aspects 2-3, wherein filtering the measured torque comprises: filtering the measured torque based on disturbances associated with sensor data of the vehicle or actuator responses of the vehicle.
Aspect 5: The method of any of Aspects 1-4, wherein the steering request transitions from the feature steering request associated with the ADAS feature to the driver steering request in accordance with a rate limitation.
Aspect 6: The method of Aspect 5, wherein the rate limitation is linear.
Aspect 7: The method of Aspect 5, wherein the rate limitation is associated with a Gaussian distribution, or wherein the steering request transitions from the feature steering request associated with the ADAS feature to the driver steering request in accordance with a hyperbolic tangent function.
Aspect 8: The method of any of Aspects 1-7, further comprising extrapolating the driver steering request over an amount of time corresponding to a delay between outputting the steering request and an actuator response to steer the vehicle based on the steering request, wherein the steering request transitions from the feature steering request to the extrapolated driver steering request.
Aspect 9: The method of Aspect 8, wherein the extrapolation of the driver steering request is linear.
Aspect 10: The method of Aspect 8, wherein the extrapolation of the driver steering request is second order based on a rate of the driver steering request.
Aspect 11: The method of any of Aspects 1-10, wherein the steering request is a pinion angle request.
Aspect 12: The method of any of Aspects 1-10, wherein the steering request is a curvature request.
Aspect 13: The method of any of Aspects 1-12, further comprising: detecting a lack of driver interaction based on subsequent measured torque on the steering column; and transitioning, in connection with detecting the lack of driver interaction, control of the vehicle from the driver to the ADAS feature by outputting a subsequent steering request that transitions from the driver steering request to the feature steering request associated with the ADAS feature.
Aspect 14: The method of Aspect 13, wherein the subsequent steering request transitions from the driver steering request to the feature steering request associated with the ADAS feature in accordance with a rate limitation.
Aspect 15: A system configured to perform one or more operations recited in one or more of Aspects 1-14.
Aspect 16: An apparatus comprising means for performing one or more operations recited in one or more of Aspects 1-14.
Aspect 17: A non-transitory computer-readable medium storing a set of instructions, the set of instructions comprising one or more instructions that, when executed by a device, cause the device to perform one or more operations recited in one or more of Aspects 1-14.
Aspect 18: A computer program product comprising instructions or code for executing one or more operations recited in one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device associated with a vehicle, the device comprising:
a processing system that includes one or more processors and one or more code-storing memories coupled with the one or more processors, the processing system configured to cause the device to:
detect a driver interaction based on measured torque on a steering column of the vehicle; and
transition, in connection with detecting the driver interaction, control of the vehicle from an advanced driver assistance system (ADAS) feature to a driver by outputting a steering request that transitions from a feature steering request associated with the ADAS feature to a driver steering request.

2. The device of claim 1, wherein the processing system, to cause the device to detect the driver interaction, is configured to cause the device to:
filter the measured torque, resulting in a filtered measured torque associated with the driver interaction; and
detect the driver interaction based on a comparison of the filtered measured torque to a threshold.

3. The device of claim 2, wherein the processing system, to cause the device to filter the measured torque, is configured to cause the device to:
filter the measured torque using at least one of a low pass filter, a high pass filter, a lead-lag compensator, or a Kalman filter.

4. The device of claim 2, wherein the processing system, to cause the device to filter the measured torque, is configured to cause the device to:
filter the measured torque based on disturbances associated with sensor data of the vehicle or actuator responses of the vehicle.

5. The device of claim 1, wherein the steering request transitions from the feature steering request associated with the ADAS feature to the driver steering request in accordance with a rate limitation.

6. The device of claim 5, wherein the rate limitation is linear.

7. The device of claim 5, wherein the rate limitation is associated with a Gaussian distribution, or wherein the steering request transitions from the feature steering request associated with the ADAS feature to the driver steering request in accordance with a hyperbolic tangent function.

8. The device of claim 1, wherein the processing system is configured to cause the device to extrapolate the driver steering request over an amount of time corresponding to a delay between outputting the steering request and an actuator response to steer the vehicle based on the steering request, wherein the steering request transitions from the feature steering request to the extrapolated driver steering request.

9. The device of claim 8, wherein the extrapolation of the driver steering request is linear.

10. The device of claim 8, wherein the extrapolation of the driver steering request is second order based on a rate of the driver steering request.

11. The device of claim 1, wherein the steering request is a pinion angle request or a curvature request.

12. The device of claim 1, wherein the processing system is configured to cause the device to:
detect a lack of driver interaction based on subsequent measured torque on the steering column; and
transition, in connection with detecting the lack of driver interaction, control of the vehicle from the driver to the ADAS feature by outputting a subsequent steering request that transitions from the driver steering request to the feature steering request associated with the ADAS feature.

13. The device of claim 12, wherein the subsequent steering request transitions from the driver steering request to the feature steering request associated with the ADAS feature in accordance with a rate limitation.

14. A method performed by a device associated with a vehicle, comprising:
detecting a driver interaction based on measured torque on a steering column of the vehicle; and
transitioning, in connection with detecting the driver interaction, control of the vehicle from an advanced driver assistance system (ADAS) feature to a driver by outputting a steering request that transitions from a feature steering request associated with the ADAS feature to a driver steering request.

15. The method of claim 14, wherein detecting the driver interaction comprises:
filtering the measured torque, resulting in a filtered measured torque associated with the driver interaction; and
detecting the driver interaction based on a comparison of the filtered measured torque to a threshold.

16. The method of claim 14, wherein the steering request transitions from the feature steering request associated with the ADAS feature to the driver steering request in accordance with a rate limitation.

17. The method of claim 14, further comprising extrapolating the driver steering request over an amount of time corresponding to a delay between outputting the steering request and an actuator response to steer the vehicle based on the steering request, wherein the steering request transitions from the feature steering request to the extrapolated driver steering request.

18. The method of claim 14, wherein the steering request is a pinion angle request or a curvature request.

19. The method of claim 14, further comprising:
detecting a lack of driver interaction based on subsequent measured torque on the steering column; and
transitioning, in connection with detecting the lack of driver interaction, control of the vehicle from the driver to the ADAS feature by outputting a subsequent steering request that transitions from the driver steering request to the feature steering request associated with the ADAS feature.

20. A non-transitory computer-readable medium storing a set of instructions, the set of instructions comprising:
one or more instructions that, when executed by one or more processors of a device associated with a vehicle, cause the device to:
detect a driver interaction based on measured torque on a steering column of the vehicle; and
transition, in connection with detecting the driver interaction, control of the vehicle from an advanced driver assistance system (ADAS) feature to a driver by outputting a steering request that transitions from a feature steering request associated with the ADAS feature to a driver steering request.
